(19) United States
(12) Patent Application Publication
(10) Pub. No.: US 2012/0018356 A1
(43) Pub. Date: Jan. 26, 2012

(54) TITLE OF INVENTION METHOD AND DEVICE FOR DETERMINING PLANT MATERIAL QUALITY USING IMAGES CONTAINING INFORMATION ABOUT THE QUANTUM EFFICIENCY AND THE TIME RESPONSE OF THE PHOTOSYNTHTIC SYSTEM

(76) Inventors: Hendrik Jalink, Dodewaard (NL); Rob Van Der Schoor, Overasselt (NL)

(21) Appl. No.: 13/203,868

(22) PCT Filed: Mar. 3, 2010
(86) PCT No.: PCT/NL2010/050105

§ 371 Date: Oct. 7, 2011

(51) Int. Cl. B07C 5/00; G01N 21/64

(52) U.S. Cl. 209/576; 250/459.1; 250/458.1

(57) ABSTRACT

The present invention relates to a method for determining the quality of plant material by irradiating said plant material with a beam consisting of several consecutive light pulses of electromagnetic radiation comprising one or more such wavelengths, that at least a part of the chlorophyll present is excitated by at least a part of the radiation, and for each light pulse measuring the fluorescence radiation originating from the plant material and associated with the chlorophyll transition with an imaging detector for obtaining the chlorophyll fluorescence images. The invention also relates to calculating characteristic chlorophyll fluorescence images from the chlorophyll fluorescence images that contain information about the quantum efficiency and the time response of the photosynthetic activity of the photosynthetic system of the plant material. The invention further relates to a device for recording and processing the chlorophyll fluorescence images and to methods and devices for sorting and separating plant material.

A method and a device for making images containing information about the quantum efficiency and the time response of the photosynthetic system with the purpose of determining the quality of plant material and a method and a device for measuring, classifying and sorting plant material

The present invention relates to a method for determining the quality of plant material, such as for instance whole plants, leaf material, fruits, berries, flowers, flower organs, roots, seeds, bulbs, algae, mosses and tubers of plants, by making chlorophyll fluorescence images. The invention particularly relates to a method wherein from the measured chlorophyll fluorescence images two characteristic chlorophyll fluorescence images are calculated and more particularly to a method wherein said characteristic fluorescence images contain information about the quantum efficiency and the time response of the photosynthetic activity of the photosynthetic system of the plant material. The present invention furthermore relates to a device for measuring the chlorophyll fluorescence images and on the basis thereof calculating images that are a measure for the quantum efficiency and the time response of the photosynthetic activity of the photosynthetic system of plant material, The present invention also relates to a device for sorting and classifying plant material based on the chlorophyll fluorescence images and the images calculated on the basis thereof that are a measure for the quantum efficiency and the time response of the photosynthetic activity of the photosynthetic system of the plant material.

### PRIOR ART

The usual measuring method for measuring the quantum efficiency of the photosynthetic activity of plant material, is measuring the photosynthetic activity using the pulse amplitude modulation (PAM) fluorometer of U. Schreiber, described in “Detection of rapid induction kinetics with a new type of high frequency modulated chlorophyll fluorometer” Photosynthesis Research (1986) 9: 261-272. In this method the quantum efficiency of the photosynthetic activity is determined. For that purpose first the fluorescence yield, F0, is measured for a plant adapted to the dark in the dark or at a tow light intensity of the ambient light. Then the maximum fluorescence yield, Fm, is determined at a saturating light pulse. From the two measuring signals the efficiency of the photosynthetic system can be calculated according to Q=(Fm-F0)/Fm. Said measuring method determines the efficiency of the photosynthetic system of a small surface of a leaf, a so-called spot measurement and therefore is not imaging.

Known measuring methods that are imaging, work according to the same principle as the PAM fluorometer. Imaging here means that an image of the plant material is obtained in which the intensity distribution, that means the local intensity, of the chlorophyll fluorescence is shown. A known measuring method is the one of B. Genty and S. Meyer, described in “Quantitative mapping of leaf photosynthesis using chlorophyll fluorescence imaging” Australian Journal of Plant Physiology (1995) 22: 277-284. In this method the surface of the plant material, for instance a leaf, is irradiated in short pulses with electromagnetic radiation from a lamp and the fluorescence is measured during the pulses with a camera system. Said first measurement takes place in the dark or at a low light intensity and results in the F0 measurement. The next measurement is carried out at a saturating light pulse and results in the Fm measurement. From said measurements an image of the efficiency of the photosynthetic system can be calculated. A drawback of this method is that the measurement for obtaining the F0 image has to be carried out in the dark. Said method is unsuitable for measurements in the light.

In European patent No. 1 563 282 “Method and a device for making images of the quantum efficiency of the photosynthetic system with the purpose of determining the quality of plant material and a method for classifying and sorting plant material” Jalink, H., R. van der Schoor and

A.H.C.M. Schapendonk describe a measuring method with which a large surface can be irradiated. In this method a large surface is irradiated by moving a laser line over the plant material by means of a rotatable mirror. By making two images at different speeds of the laser line a measure for the efficiency of the photosynthesis can be calculated. A drawback of this method is that the overall measuring time is approximately 10 to 20 seconds and that the measurements cannot be taken in the light.

### SUMMARY OF THE INVENTION

It is an object of the present invention to provide a method to measure the chlorophyll fluorescence in an imaging manner and to determine the quantum efficiency and the time response of the photosynthetic activity of plant material from the obtained chlorophyll fluorescence images, in which the drawback of the long measuring time and the inability to measure in the light of the known measuring methods is overcome.

The present invention therefore provides a method for determining the quality of plant material by determining chlorophyll fluorescence images of said plant material, the plant material being irradiated with a beam of electromagnetic radiation comprising one or more such wavelengths, that at least a part of the chlorophyll present is excitated by at least a part of the radiation, wherein the beam of electromagnetic radiation irradiates the whole of the plant material, the beam consists of several consecutive light pulses such that at least the last light pulse saturates the photosynthetic system of the plant material, and for each light pulse the fluorescence radiation originating from the plant material and associated with the chlorophyll transition, is measured with an imaging detector for obtaining the chlorophyll fluorescence images.

According to a preferred embodiment a characteristic chlorophyll fluorescence image containing information about the quantum efficiency of the photosynthetic activity, QEP, of the photosynthetic system of the plant material, is calculated with the formula:

QEP(i)=(Fsat(i)−Fstart(i))/Fsat(i)

Fsat(i)=the intensity of the fluorescence of pixel i obtained when the photosynthesis is saturated after a series of pulses,

Fstart=the fluorescence of pixel i measured over the first pulse, and wherein the calculation is carried out for each pixel i of the images.

According to a further preferred embodiment a characteristic chlorophyll fluorescence image containing information about the time response of the photosynthetic activity of the photosynthetic system of the plant material, is calculated with the formula:

F(t,i)=Fstart(i)+(Fsat(i)−Fstart(i))*(1-Exp(−t/TR(i)))

Fsat(i)=the intensity of the fluorescence of pixel i obtained when the photosynthesis is saturated after a series of pulses,

Fstart(i)=the fluorescence of pixel i measured over the first pulse,

F(t,i)=the course of the fluorescence of pixel i in time, and t=time

wherein the calculation is carried out for each pixel i of the images.

### SHORT DESCRIPTION OF THE FIGURES

FIG. 1 schematically shows an example of a device for making chlorophyll fluorescence images and determining therefrom the characteristic chlorophyll fluorescence images that contain information about the quantum efficiency and the time response of the photosynthetic activity of the photosynthetic system of plant material. The plant material 5) is exposed to a light source 2) consisting of LEDs (Light Emitting Diodes) that receive their power from a pulsed power supply 3) that is controlled by a computer 4) and the chlorophyll fluorescence is measured by a camera 1) that is read by the computer.

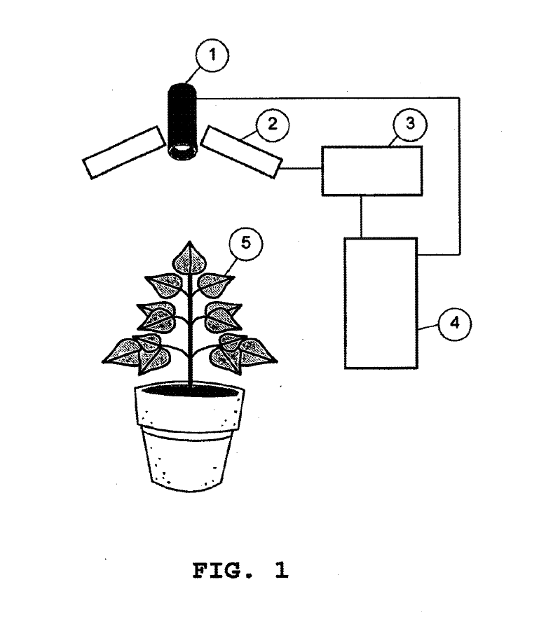

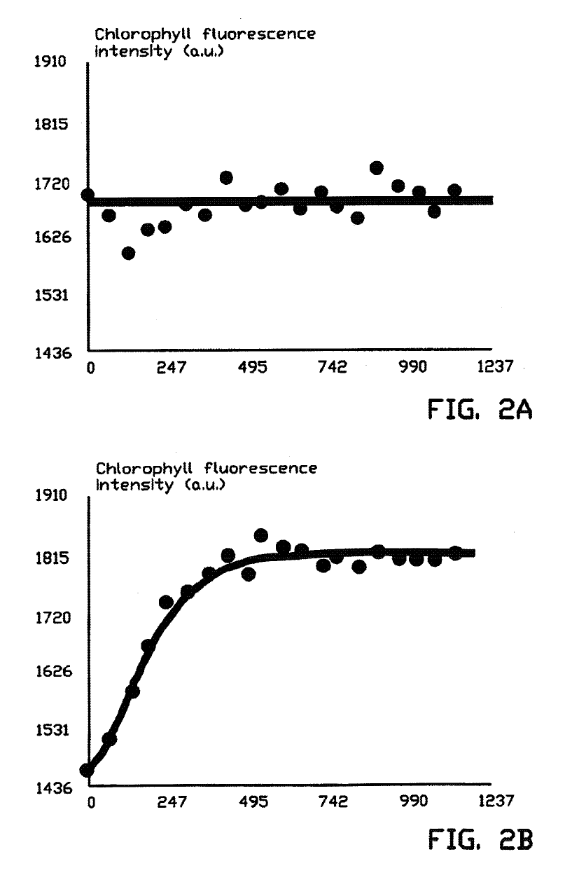

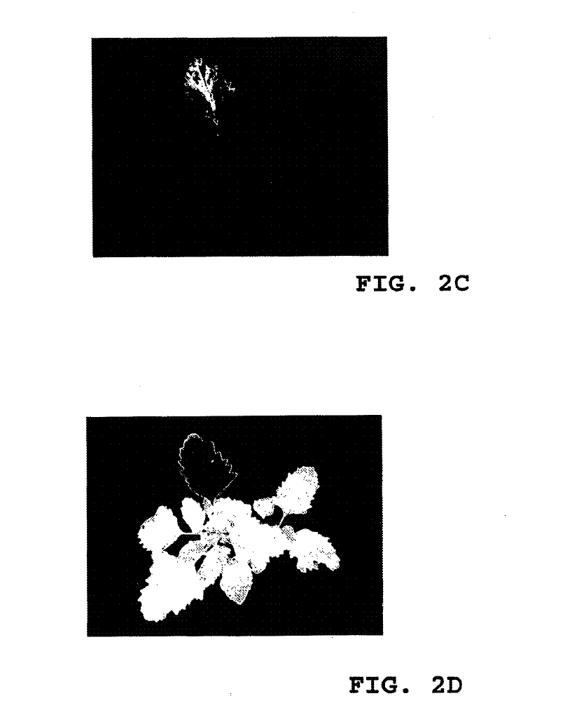

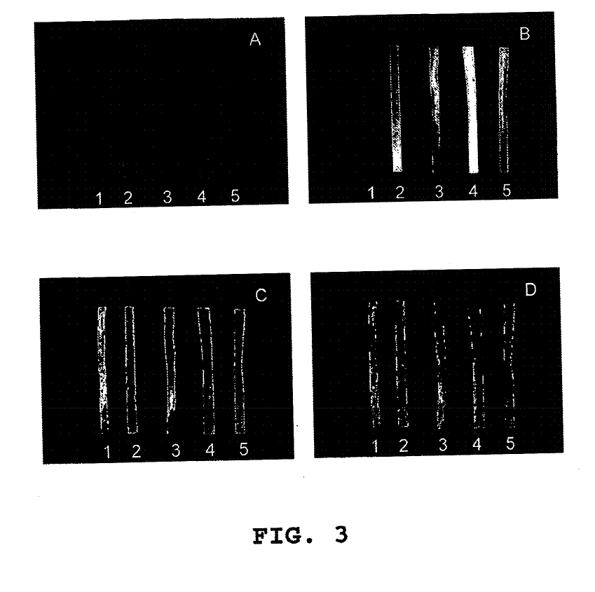

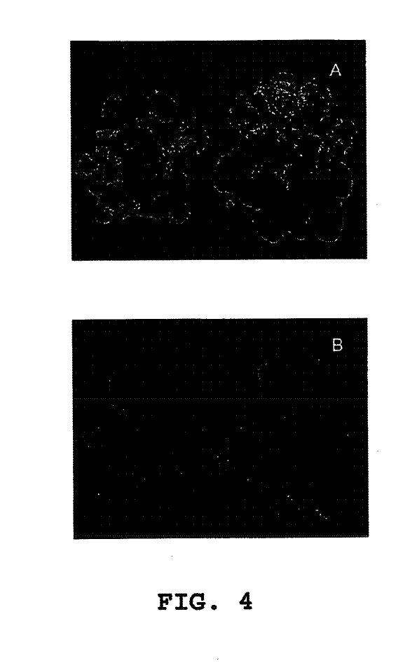

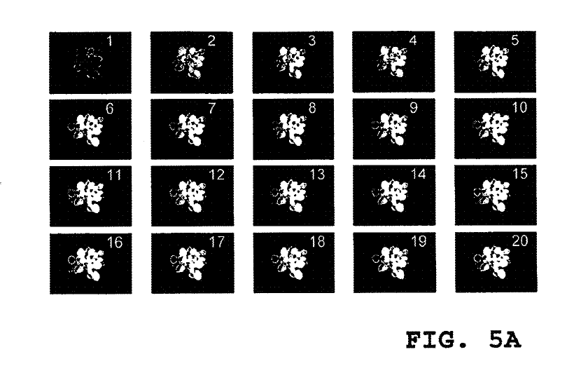

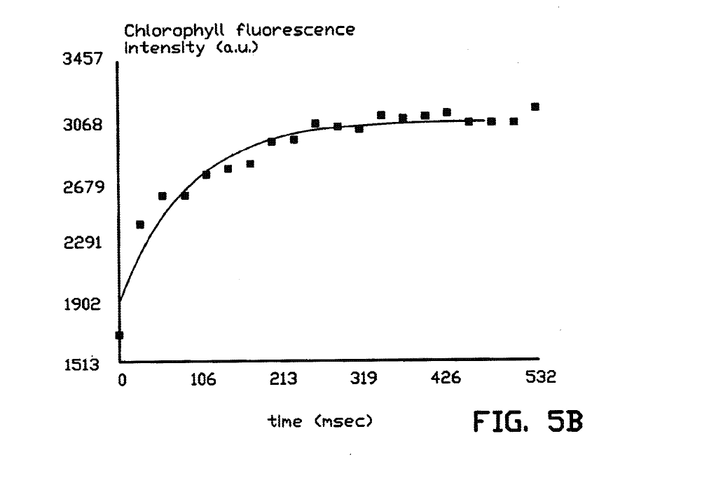

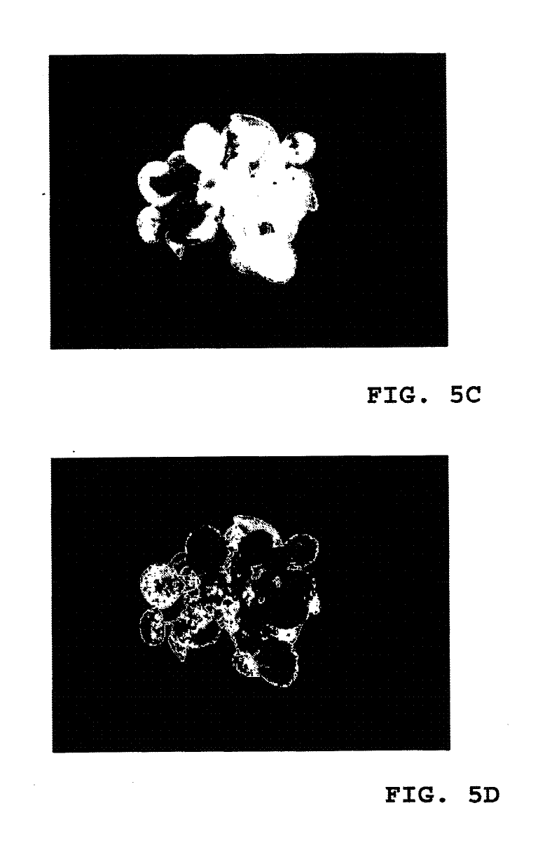

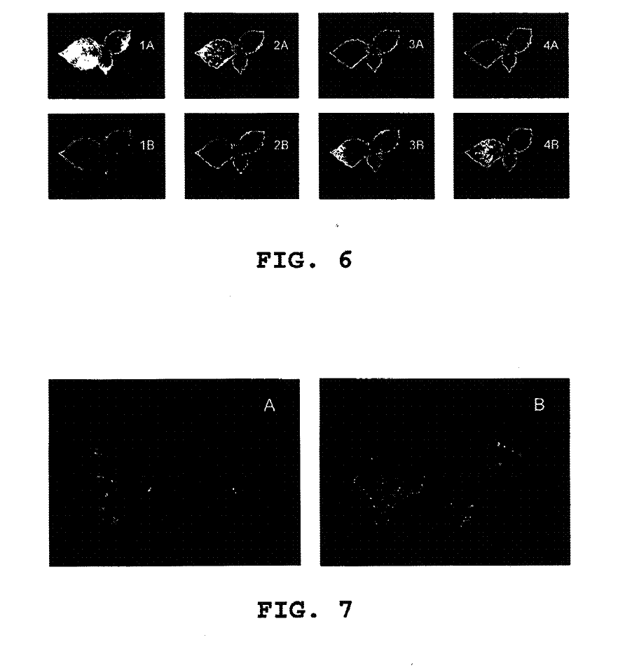

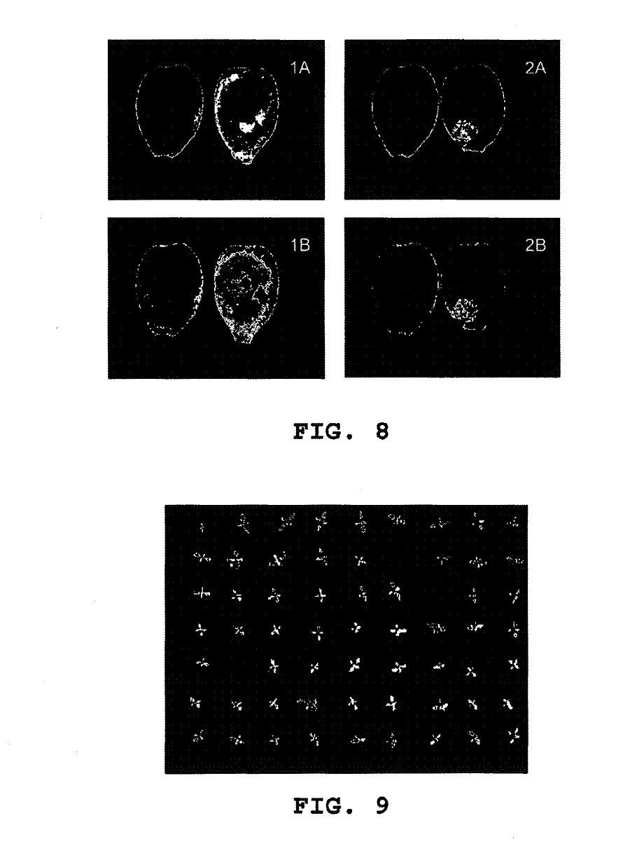

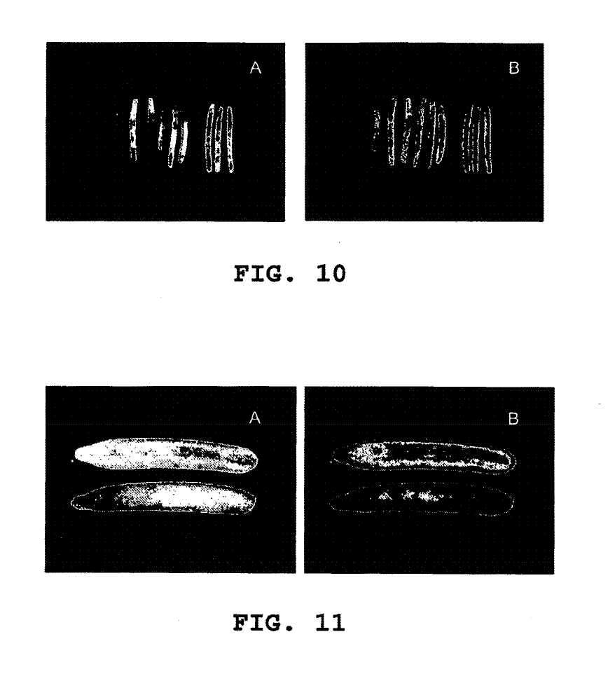

In FIG. 2 a chlorophyll fluorescence image is shown that is obtained with a device according to FIG. 1 for a White Goosefoot plant (Chenopodium album). FIG. 2A shows the result of the time response of 20 images of one pixel of the CCD-camera of the leaf of the plant that is under stress as a result of a herbicide treatment performed 48 hours previously; FIG. 2B shows the result of the time response of 20 images of one pixel of the CCD-camera of the leaf of the plant in which the photosynthesis functions normally; FIG. 2C shows the result of the chlorophyll fluorescence image of the last pulse; FIG. 2D shows the result of a QEP-image calculated with formula (1), which QEP-image contains information about the quantum efficiency of the photosynthetic activity of the photosynthetic system. In FIG. 2A and 28 the vertical axis shows the intensity of the chlorophyll fluorescence in arbitrary units and the horizontal axis shows the time in milliseconds,

In FIG. 3 chlorophyll fluorescence images are shown that were obtained with a device according to FIG. 1 for five leaves of barley (Hordeum vulgare). Leaves 2 and 4 are healthy, leaves 1, 3 and 5 are affected by the septoria pathogen (Mycosphaerella grandnicata). FIGS. 3A and 3B show the result of the first, Fstart, and the last, Fsat, LED-pulse, respectively, of the chlorophyll fluorescence image. FIG. 3C shows the result of a QEP-image calculated with formula (1), which QEP-image contains information about the quantum efficiency of the photosynthetic activity of the photosynthetic system. FIG. 3D shows the result of a TR-image calculated with formula (2), which TR-image contains information about the time response of the photosynthetic activity of the photosynthetic system.

In FIG. 4 the chlorophyll fluorescence images are shown that were obtained with a device according to FIG. 1 for two African violet plants (Saintpaulia lonantha). FIGS. 4A and 4B show the result of QEP-images calculated with formula (1), which QEP-images contain information about the quantum efficiency of the photosynthetic activity of the photosynthetic system. The plant on the left in FIGS. 4A and 4B is the same plant and looks fine on the face of it, but is in fact dehydrating. The plant has not been watered for approximately five days. The plant on the right in FIGS. 4A and 4B is the same plant and has had sufficient water and looks fine. For FIG. 4A the measurements were carried out in the dark and for FIG. 4B in the light.

In FIG. 5A twenty individual chlorophyll fluorescence images are shown that were obtained with the device according to FIG. 1 for a healthy African violet plant (Saintpaulia ionantha). FIG. 5B shows the average fluorescence intensity of each individual image. On the horizontal axis time is plotted and on the vertical axis the intensity of the chlorophyll fluorescence in arbitrary units. The curve shows the best fit through the points of measurement. FIG. 5C shows the result of a QEP-image calculated with formula (1), which QEP-image contains information about the quantum efficiency of the photosynthetic activity of the photosynthetic system. FIG. 5D shows the result of a TR-image calculated with formula (2), which TR-image contains information about the time response of the photosynthetic activity of the photosynthetic system.

FIG. 6 shows the effect of cutting off a leaf from a black nightshade plant (Solanum nigrum). Chlorophyll fluorescence images were obtained with a device according to FIG. 1 in the light. Image 1A of FIG. 6 shows the QEP-image of the photosynthetic activity of a plant that is healthy and intact, calculated for each pixel of the image according to formula 1 from thirty recorded fluorescence images. Image 1B of FIG. 6 shows the TR-image of the response of the photosynthetic activity calculated for each pixel of the image according to formula 2 from thirty recorded fluorescence images. After 1 minute the left leaf was cut off from the main stem. After 15, 30 and 60 minutes the measurements and calculations were repeated which for the QEP-image resulted in the images 2A, 3A and 4A, respectively, and for the TR-image resulted in the images 2B, 3B and 4B, respectively.

FIGS. 7A and 7B show the effect of salt stress on a potato plant (Solanum tuberosum). Chlorophyll fluorescence images were obtained with a device according to FIG. 1 at low light. FIG. 7A shows the QEP-image of the photosynthetic activity of a plant that is healthy and intact, calculated for each pixel of the image according to formula 1 from thirty recorded fluorescence images. FIG. 7B shows the TR-image of the response of the photosynthetic activity calculated for each pixel of the image according to formula 2 from thirty recorded fluorescence images. The plant on the left in FIG. 7A and FIG. 7B was treated with a water solution containing salt, whereas the plant on the right is a control plant that was treated with normal water.

FIG. 8 shows the effect of rot and a spot in the early stages of rot on kiwifruits (Actinidia chinensis). Chlorophyll fluorescence images were obtained with a device according to FIG. 1. Panel 1A of FIG. 8 shows the QEP-image of the photosynthetic activity of a fruit of good quality without rot (left) and a fruit with a spot affected by rot (right), calculated for each pixel of the image according to formula 1 from four fluorescence images. Panel 18 shows the corresponding TR-image. Panels 2A and 2B are analogous to panels 1A and 1B but now the fruit on the right has been replaced by a fruit having a spot in the early stages of rot.

FIG. 9 shows the effect of the quality of petunia (Petunia) seedlings. Chlorophyll fluorescence images were obtained with a device according to FIG. 1 from a tray of petunia seedlings in potting soil in a grid of 9 plants horizontally and 7 plants vertically. FIG. 9 shows the QEP-image of the photosynthetic activity that was calculated for each pixel of the image according to formula 1 from twenty fluorescence images.

FIG. 10 shows the effect of spots in the early stages of rot on green beans (Phaseolus vulgaris). Chlorophyll fluorescence images were obtained with a device according to FIG. 1 from nine beans. FIG. 10A shows a QEP-image of the photosynthetic activity calculated for each pixel of the image according to formula 1 from ten fluorescence images. FIG. 10B shows the TR-image of the response of the photosynthetic activity calculated for each pixel of the image according to formula 2 from ten fluorescence images. On the left six beans can be seen showing spots in the early stages of rot whereas the three beans on the right are of good quality and do not show rot.

FIG. 11 shows the effect of quality (softening) of cucumber (Cucumis sativus). Chlorophyll fluorescence images were obtained with a device according to FIG. 1. FIG. 11 A shows the QEP-image of the photosynthetic activity of cucumbers of inferior quality (top) and good quality (bottom), calculated for each pixel of the image according to formula 1 from twenty fluorescence images. FIG. 11B shows the TR-images of the response of the photosynthetic activity for the cucumbers, calculated for each pixel of the image according to formula 2 from twenty recorded fluorescence images.

### DETAILED DESCRIPTION

The present invention is based on a spectroscopic measurement that is highly specific to the chlorophyll present and the functioning of the photosynthetic system. The functioning of the photosynthetic system is very important to the proper functioning of a plant and the quality of the plant. Light is captured by the chlorophyll molecules. If the plant is of a good quality and is not subjected to stress, the captured energy of the chlorophyll molecules will quickly be passed on to the photosynthetic system for conversion into chemical energy. Chlorophyll has the property that it shows fluorescence. When the energy can be processed sufficiently fast by the photosynthetic system this results in a low level of fluorescence light. When the photosynthetic system cannot process the energy sufficiently fast, the fluorescence light will increase in intensity. When switching on short light pulses of a saturating light source having electromagnetic radiation which is absorbed by the chlorophyll, in case the photosynthetic system is able to process the energy fast, the emitted fluorescence increases from a low level per light pulse to a maximum level. In a situation in which the photosynthetic system is unable to process the energy fast, the emitted fluorescence will hardly increase per pulse as from the first light pulses and almost immediately reach the maximum level. This property is now utilised to make an image that is characteristic for the quantum efficiency and the time response of the photosynthetic activity of the photosynthetic system. The method of the invention makes it possible to form an image that is characteristic for the quantum efficiency and the time response of the photosynthetic activity of the photosynthetic system of whole plants. Because the proper functioning of the photosynthetic system is related to the quality of the plant material the characteristic images of the quantum efficiency and the time response of the photosynthetic activity of the photosynthetic system can be used for establishing the quality of plant material, such as the reaction of the plant to dosage of CO₂ (carbon dioxide), temperature, quantity of light in the form of additional light or screens, composition of the colour of the light, quantity and composition of nutrients, air humidity, water dose, the presence of diseases, dehydration, damage by insects, damage as a result of too much light (photo inhibition), damage due to bruising and wounds. Said images can also be used for selecting plant material on quality. When selecting on quality for instance it can be determined beforehand from a sample of plant material what the QEP- or TR-threshold value is that is associated with a minimum quality or which

QEP- or TR-values are associated with a certain class of quality.

In the method of the invention plant material is irradiated with electromagnetic radiation having such a wavelength that at least a part of the chlorophyll present is excitated, for instance using electromagnetic radiation having a wavelength of between 200 and 750 nm such as from high power LEDs (Light Emitting Diodes), lasers or lamps with suitable optical filters. The fluorescence is measured with an imaging detector, for instance with a camera, between 600 and 800 nm, for instance around 730 nm. The beam of electromagnetic radiation can for instance be obtained by means of computer-controlled LEDs producing a beam of light flashes that is directed at the plant material. First light pulses having a pulse duration of 3 milliseconds can be directed at the plant material with a duty cycle of approximately 10%, that means that the intervals between the pulses are nine times longer than the pulses. During each light pulse the fluorescence is measured by an image detector. In total a series of for instance 20 light pulses is made and for each pulse the image from the camera is sent to the computer or first the 20 images are stored in the camera in a memory and sent to the computer after the last light pulse. From this series of images an image can be calculated containing information about the quantum efficiency of the photosynthetic activity of the photosynthetic system (Quantum Efficiency Photosynthesis: QEP) with the following formula (1):

QEP(i)=(Fsat(i)−Fstart(i))/Fsat(i) (1)

in which

Fsat(i)=the intensity of the fluorescence of pixel i obtained when the photosynthesis is saturated after a series of pulses,

Fstart (i)=the fluorescence of pixel i measured over the first pulse, and i=pixel i of the image sensor

A chlorophyll fluorescence image is built up from discrete pixels forming the sensor of the camera (for instance a CCD-chip having 640 horizontal lines of pixels and 480 vertical lines of pixels, in this example having a total of 640×480=307.200 pixels. Each pixel in the chlorophyll fluorescence image has an intensity value that is a measure for the chlorophyll fluorescence value on the corresponding position of the plant material. The image of QEP is calculated according to formula (1), for instance using a computer, by carrying out this calculation for each pixel i of QEP on the measured images of the chlorophyll fluorescence of the plant material. This results in the characteristic chlorophyll fluorescence image as an intensity distribution that contains information about the quantum efficiency of the photosynthetic activity of the photosynthetic system of the plant material.

From said series of images furthermore an image can be calculated containing information about the time response of the photosynthetic activity of the photosynthetic system (Time Response: TR) calculated for each pixel of the TR-image with the following formula (2) by curve fitting to the chlorophyll fluorescence intensity measured for each pulse and corresponding pixel of each fluorescence image:

F(t,i)=Fstart(i)+(Fsat(i)−Fstart(i))*(1−Exp(−t/TR(i))) (2)

in which

Fsat(i)=the intensity of the fluorescence of pixel i obtained when the photosynthesis is saturated after a series of pulses,

Fstart(i)=the fluorescence of pixel i measured over the first pulse,

F(t,i)=the course of the fluorescence of pixel i in time,

t=time, and

i=pixel i of the image sensor

For each image pixel i of the plant material the calculation according to formula (2) is carried out, for instance using a computer. This results in the characteristic chlorophyll fluorescence image as an intensity distribution containing information about the time response of the photosynthetic activity of the photosynthetic system of the plant material.

The characteristic chlorophyll fluorescence images obtained from the chlorophyll fluorescence images with the formulas (1) and (2) provide the advantage that they depend little on factors such as selected pulse duration, pulse intensity, distance between light source and plant material, distance between image sensor and plant material, choice of used instrumentation such as exposure and camera sensor.

For irradiating the plant material a laser, lamp or LED-lamp can be used that irradiates the plant material with electromagnetic radiation, such that the electromagnetic radiation irradiates the plant material as a whole and evenly. The fluorescence radiation originating from the plant material can be measured using any suitable imaging detector, for instance a video camera, CCD-camera, line scan camera or a number of photodiodes or photomultipliers.

The intensity of the electromagnetic radiation, or the power of the electromagnetic radiation per surface unit with which the plant material is irradiated, the pulse duration and the duty cycle preferably are selected such that the photosynthetic system at several light pulses of 10-20 pulses is saturated for said last 10-20 pulses, the QEP-value according to formula (1) results in a value for a normally functioning photosynthetic system of a plant of between 0.5-0.85 and the TR-value according to formula (2) results in a value for a normally functioning photosynthetic system of a plant of between 10-100 ms.

The invention furthermore relates to a device for determining the quality of plant material using the method described above, comprising a light source for irradiating the whole of the plant material with a beam of electromagnetic radiation comprising one or more such wavelengths, that at least a part of the chlorophyll present in the plant material is excitated by at least a part of the radiation, wherein the beam consists of several consecutive pulses, means for measuring the fluorescence radiation originating from the plant material and associated with each pulse for obtaining a series of chlorophyll fluorescence images and means for processing the chlorophyll fluorescence images for obtaining the characteristic chlorophyll fluorescence images of the quantum efficiency and the time response of the photosynthetic activity of the photosynthetic system of the plant material.

The invention is highly sensitive, fully non-destructive and imaging. These are the characteristics of the invention that make it possible to make a sorting device or classification device with which plant material can be selected or classified on the basis of the QEP- and/or TR-measurement. As the QEP- and the TR-measurement have a direct relation to the quality of the plant material, sorting or classifying on quality is possible.

The invention therefore also relates to methods for separating or classifying plant material consisting of individual components into several fractions each having a different quality, wherein the characteristic chlorophyll fluorescence images are determined for each component using a method or device for determining the quality of plant material according to the invention and the fractions of components having the QEP-value and/or the TR-value in the same pre-determined range are collected.

The invention furthermore relates to a device for separating plant material using the method mentioned above, comprising a supply part for the plant material, a part for the irradiation of the whole of the plant material with a beam of electromagnetic radiation comprising one or more such wavelengths, that at least a part of the chlorophyll present in the plant material is excitated by at least a part of the radiation, wherein the beam consists of several consecutive pulses, a part for the measuring of the fluorescence radiation originating from the plant material and associated with each pulse for obtaining a series of chlorophyll fluorescence images, a part for the processing of the chlorophyll fluorescence images for obtaining a characteristic chlorophyll fluorescence image of the quantum efficiency or the time response of the photosynthetic activity of the photosynthetic system of the plant material and a separation part that works on the basis of one or a combination of both characteristic chlorophyll fluorescence images of the quantum efficiency and the time response of the photosynthetic activity.

The invention further relates to a device for classifying plant material using the method mentioned above, comprising a moving structure for localising the plant material, for instance a moving carriage or robot arm, a part for the irradiation of the whole of the plant material with a beam of electromagnetic radiation comprising one or more such wavelengths, that at least a part of the chlorophyll present in the plant material is excitated by at least a part of the radiation, wherein the beam consists of several consecutive pulses, a part for the measuring of the fluorescence radiation originating from the plant material and associated with each pulse for obtaining a series of chlorophyll fluorescence images, a part for the processing of the chlorophyll fluorescence images for obtaining a characteristic chlorophyll fluorescence image of the quantum efficiency or the time response of the photosynthetic activity of the photosynthetic system of the plant material and a classification part that works on the basis of one or a combination of both characteristic chlorophyll fluorescence images of the quantum efficiency and the time response of the photosynthetic activity.

The material to be sorted or classified may consist of whole plants, cut flowers, leaf material, fruits, berries, vegetables, flowers, flower organs, roots, tissue culture, seeds, bulbs, algae, mosses and tubers of plants etc.. The fractions into which the plant material is separated or classified, may each consist of individual whole plants, cut flowers, leaf material, fruits, berries, vegetables, flowers, flower organs, roots, tissue culture, seeds, bulbs, algae, mosses and tubers of plants etc.

The present invention can be utilised for sophisticated purposes, such as early selection of seedlings on stress tolerance, programmed administering of herbicides and quality check in greenhouse culture. The method according to the invention can be used in screening plant quality in the seedling stage at the nursery. Trays of seedlings can be tested. Seedlings of an inferior quality can be removed and replaced by good seedlings. The method according to the invention can also be used for selecting seedlings on stress sensitivity by subjecting the trays to infectious pressure or to abiotic stress factors and registering the signal build-up “on-line”. Damage to plant material due to diseases can be detected at a very early stage in the chlorophyll fluorescence image as a local increase of the fluorescence. In the QEP-image this is detected as a local decrease of the quantum efficiency of the photosynthetic activity of the photosynthetic system. At the auction plants can be checked on quality. A fast, non-destructive and objective method for establishing the pot plant quality and the vase quality of flowers supplied at the auction or even during cultivation is of great economic importance. The flower quality depends on the age, cultivation and optional post-harvest treatment that influence the QEP- and/or TR-images. The method according to the invention can also be used in high-throughput-screening of model crops (Arabidopsis and rice) for functional genomics research for the purpose of function analysis and trait identification. Another important use for the new invention can be found in the determination of the freshness of vegetables and fruits and the presence of damage, for instance in the form of diseases. In the QEP-image damage shows a lower QEP-value than the healthy parts of the plant material.

In general it has to be established from tests at which QEP- and/or TR-values in the image sorting or classification can be based. In a test of several stages of damages the QEP- and TR-value in the image of the damage are measured and divided into various classes. Subsequently during the growth or storage it is established what classes result in a high quality. The threshold values found in this test are used as value for QEP and/or TR in order to select on. Selection can for instance take place on the basis of the average over the leaf surface (meaning the average of the QEP- or TR-values of all pixels over the leaf surface rise above a threshold value of QEP or within a range value of TR). Preferably selection takes place on the basis of a threshold percentage of the leaf surface (meaning the QEP- or TR-value of each pixel of at least a certain percentage of the leaf surface rises above a threshold value of QEP or within a range value of TR). This way of selection is much more sensitive than on the average.

A preferred embodiment of a device for measuring the chlorophyll fluorescence images is shown in FIG. 1. This is a simple form the device may have. Several LEDs having a wavelength between 200 and 750 nm, and preferably of 670 nm, (1) produce a light beam of high intensity of, expressed in quantity of photons, approximately 500 to 1000 μmol/m².second, that is directed at the plant material (4). The LED-light serves to excitate the chlorophyll molecules. At least a part of the chlorophyll molecules will get into an electronically excitated state. At least a part of the chlorophyll molecules will fall back to the ground state under emission of fluorescence. The fluorescence is measured with a camera that is provided with an optical filter, suitable for only transmitting light between 600 and 800 nm, preferably around 730 nm, and selected such that the light used for excitating the chlorophyll molecules is retained as much as possible. With a series of for instance 20 pulses with a pulse duration of 3 milliseconds and a time interval between the pulses of 27 milliseconds the plant material is irradiated. During each pulse the fluorescence is measured by the camera and read by a computer. From said twenty images the QEP and TR of the photosynthetic activity of the photosynthetic system are calculated according to formula (1) and (2) for each pixel of the image.

To an expert in this field it will be clear that other intensities of the light beam, number of pulses, pulse durations and intervals between the pulses can also be used for obtaining the images QEP and TR of the photosynthetic activity of the photosynthetic system.

A device for sorting plant material according to the invention may consist of a conveyor belt for the supply of plant material to the measuring part where the above-mentioned fluorescence measurement according to the invention is carried out after which the plant material is further transported to the separation part in which the fractions of which the QEP- and/or TR-images are not within pre-determined limits, are removed from the conveyor belt in a manner known per se, for instance by an air flow. The air flow can be regulated by a valve that is controlled by means of an electronic circuit such as a microprocessor that processes the signal of the measuring part. Plant material can also be separated into different classes of quality in which for each class of quality the QEP- and/or TR-image of the plant material is within pre-determined limits. The limits can be established by for instance determining the QEP- and/or TR-image of samples of plant material having the desired quality or properties. The expert in this field will know that the plant material to be separated can also be transported through the measuring part and the separation part in another way than by means of a conveyor belt and that various methods are available to sort various fractions from the main flow, such as an air flow, liquid flow or mechanic valve. The plant material may for instance also be present in a liquid. Sorting in a liquid can for instance take place to minimise the risk of damaging highly delicate plant material, such as apples, berries and other soft fruit.

It is further noted that a device for sorting or classifying plant material, for instance in a greenhouse or in the field, according to the invention may consist of a device that moves past the plants and measures their QEP- and/or TR-image and subsequently classifies them according to quality and stores this in a database or removes the plant material of inferior quality. The purpose of a database is to provide insight into the quality of the entire batch and to allow a quick retrieval of the position of the plants that fall within a certain class of quality. The above-mentioned preferred device for the measurement can also be moved over the plant material by a robot arm or a known device such as a carriage, the objective being that deviations in the plant material, such as for instance the early detection of diseases, are measured. Detection of a disease in for instance plants can be established because a test showed that due to the damage the QEP-value on the damaged spot is locally lower and the TR-value is higher or lower than in the surrounding plant material. Subsequently in tests it was established what quantity of fungicide should be applied to the damage in order to control the disease. The present invention now allows detecting and locally controlling the disease in an automated manner by locally and in a highly dosed manner spraying the damage with a fungicide using a nozzle. Advantage of the method used is the decrease of the quantity of fungicide, so that the plants need not be sprayed with the fungicide by way of prevention.

It is also noted that the device can be used for controlling the cultivation of plants by coupling the greenhouse climate control to the information obtained with the method as described above. Advantage of the present invention is that the entire plant is imaged and therefore a proper measure for the quantum efficiency of the photosynthetic activity can be calculated and the measurement can be carried out in a very short time, this as opposed to the PAM fluorometer which only measures a small part of a leaf.

The invention can be used in any sorting device for plants or fruit. Incorporating it into any sorting device and carriages or robots that may or may not be automatically propelled, is possible.

### EXAMPLES

### Example 1

In this example the effect of a herbicide treatment on the chlorophyll fluorescence image and the QEP-image of the photosynthetic activity is described. The fluorescence images were measured with the above-mentioned preferred device according to FIG. 1. FIG. 2C shows the result of the first LED-pulse of the chlorophyll fluorescence image, Fstart, of a White Goosefoot plant (Chenopodium album) on which 48 hours previously a drop of 3 μl of herbicide solution was applied on one of the leaves. The herbicide action is visible in the image in the local lighter shade of the leaves. In FIGS. 2A and 2B the time (in ms) is plotted on the horizontal axis and the intensity of the chlorophyll fluorescence in arbitrary units is plotted on the vertical axis. In FIG. 2A it can be seen that the course of the chlorophyll fluorescence of an ill-functioning photosynthetic system is almost flat. A properly functioning photosynthetic system shows the course as indicated in FIG. 25. The signal gradually increases from a low value that is a measure for Fstart for the first pulse to a value that remains virtually constant, Fsat. FIG. 20 shows the QEP-image of the photosynthetic activity that is calculated using a computer for each pixel of the image according to formula (1) from the twenty images of FIG. 2C. In FIG. 2D the black/dark grey areas in the image of the leaves are hardly photosynthetically active anymore. The pixels have a value of QEP that is approximately between 0 and 0.2. The healthy parts of the plant do show a normal value of the QEP of the photosynthetic activity. The pixels have a value that is approximately between 0.5 and 0.85. They can be recognized from the pale grey areas. From tests it is known at which threshold values for the QEP-values of the photosynthetic activity leaves will die. Above a certain threshold value of the QEP-value of the photosynthetic activity said plant parts are still healthy. Below a certain threshold value said plant parts will die. This test showed that the threshold value was approximately 0.3. Advantage of the present invention is that now the entire plant is measured in a short time of approximately 500 ms when irradiating with ten pulses and therefore a proper opinion can be given about the overall QEP-value of the photosynthetic activity of the entire plant. This as opposed to the methods known up until now in which a spot measurement is carried out on a number of spots of the plant or only a small part of the plant is imaged, which require a longer measuring time of a few seconds.

### Example 2

In this example the effect of the septoria disease (Mycosphaerella graminloola) on the chlorophyll fluorescence image, the QEP-image and the TR-image of the photosynthetic activity of five leaves of barley (Hordeum vulgare) is described. The fluorescence images were measured using the above-mentioned preferred device according to FIG. 1. Leaves 2 and 5 are healthy, leaves 1, 3 and 4 are affected by the pathogen septoria. FIGS. 3A and 3B show the result of the first Fstart, and last, Fsat, LED pulse, respectively, of the chlorophyll fluorescence image of five barley leaves. It can clearly be seen that the fluorescence signal has increased. FIG. 3C shows the QEP-image of the photosynthetic activity that has been calculated using a computer for each pixel of the image according to formula 1 from the twenty images of FIGS. 3A and 38. In FIG. 3C the black/dark grey areas in the image of the leaves are hardly photosynthetically active anymore. The pixels have a value of QEP that is approximately between 0 and 0.2. The healthy leaves 2 and 5 show a normal value of QEP of the photosynthetic activity indeed. But so does leaf number 4. The pixels have a value that is approximately between 0.5 and 0.85. They can be recognized from the pale grey areas. From tests it can be established at what threshold values for the QEP-value of the photosynthetic activity the leaves die. Above a certain threshold value of the QEP-value of the photosynthetic activity said plant parts are still healthy. Below a certain threshold value those plant parts will die. This test also showed that the threshold value was approximately 0.3. FIG. 3D shows the TR-image of the photosynthetic activity that was calculated using a computer for each pixel of the image according to formula 2 from the twenty images of FIGS. 3A and 3B. In FIG. 3D the black/dark- pale grey specked areas in the image of the leaves are hardly photosynthetically active anymore. It regards the leaves 1, 3 and 4. The pixels have a value of TR that is approximately over 100 ms and below 10 ms. The healthy leaves 2 and 5 have an even grey colour and show a normal value of TR of the photosynthetic activity indeed. The pixels have a value that is approximately between 10 and 100 ms. The black areas in the image of the leaves are hardly photosynthetically active anymore. The pixels have a value of TR that is approximately below 10 ms. This test showed that the TR-value indicated that the leaf is affected by septoria sooner than the QEP-value does. According to the QEP-value leaf 4 was healthy but according to the TR-value it was unhealthy. With the TR-value it could be established sooner that leaf 4 was ill. From tests it is known at what threshold values for the TR-value of the photosynthetic activity the leaves die. Within a certain range of the TR-value of the photosynthetic activity said plant parts are still healthy. Beyond this range said plant parts will die. This test showed that the TR-value for a healthy plant should be in the range of approximately 10-100 ms.

### Example 3

This example shows that the measurement can be carried out in the light. This example also shows that in the light the effect of dehydration can be properly measured on the QEP-image of the photosynthetic activity. The fluorescence images were measured using the above-mentioned preferred device according to FIG. 1. The measurements were carried out on two African violet plants (Saintpaulia ionantha). The plant on the left in FIG. 4A and 4B still looks fine on the face of it but it is dehydrating. The plant has not been watered for approximately five days. The plant on the right has been watered sufficiently and looks good. For FIG. 4A the measurements were carried out in the dark and for FIG. 4B in the light at an intensity of 90 μmol/m².second. The QEP-image of the photosynthetic activity was calculated using a computer for each pixel of the image according to formula 1 from the twenty recorded images. In FIG. 4 the dark areas in the image of the leaves are hardly photosynthetically active anymore. The pixels have a value of QEP that is approximately between 0 and 0.2. The healthy parts of the plant do show a normal value of QEP of the photosynthetic activity. The pixels have a value that is approximately between 0.5 and 0.85. They can be recognized from the pale grey areas. The QEP-image of both plants of FIG. 4A does not show much stress. The pale grey areas are dominant. When the same measurement is carried out in the light, many more dark grey areas can be seen for the plant on the left in FIG. 4B. The plant on the right still shows many pale grey areas. It is known from tests at what threshold values for the QEP-values of the photosynthetic activity the leaves have a shortage of water. Above a certain threshold value of the QEP-value of the photosynthetic activity those plant parts still have sufficient water. Below a certain threshold value the plant parts have a shortage of water. Said test showed that the threshold value was approximately 0.2. Advantage of the present invention is that now the shortage of water of an entire plant is measured in a short time of approximately 500 ms and in the light. This as opposed to the methods known up until now in which measurements can only be carried out in the dark and the effects of a shortage of water cannot be measured.

### Example 4

In this example the effect of the health of African violet plants (Saintpaulia ionantha) on the chlorophyll fluorescence image, the QEP-image and TR-image of the photosynthetic activity is described. The fluorescence images were measured using the above-mentioned preferred device according to FIG. 1. FIG. 5A shows the twenty individual chlorophyll fluorescence images. Areas that have a more pale grey intensity, show an increased fluorescence. It can clearly be seen that the fluorescence signal has increased due to the higher intensity.

FIG. 5B shows the average fluorescence intensity of each individual image. On the horizontal axis the time is plotted (in Ms) and on the vertical axis the intensity of the chlorophyll fluorescence is plotted in arbitrary units. The curve shows the best fit through the points of measurement. FIG. 5C shows the QEP-image of the photosynthetic activity that was calculated using a computer for each pixel of the image according to formula 1 from the twenty images of FIG. 5A. In FIG. 3C the dark grey areas in the image of the leaves have a decreased photosynthetic activity. The pixels have a value of QEP that is approximately around 0.4. The pale grey areas of the plant show a normal value of QEP of the photosynthetic activity. The pixels have a value that is approximately between 0.5 and 0.85. FIG. 5D shows the TR-image of the photosynthetic activity that was calculated using a computer for each pixel of the image according to formula 2 from the twenty images of FIG. 5A. In FIG. 5D the pale grey areas in the image of the leaves are less photosynthetically active. The pixels have a value of TR that is approximately between 50-100 ms. The dark grey areas show a normal value of TR of the photosynthetic activity. The pixels have a value that is between approximately 10 and 50 ms. From tests it can be established at what threshold values for the TR-value of the photosynthetic activity the leaves have a normal value. Within a certain range for the TR-value of the photosynthetic activity those plant parts are still healthy. Beyond said range they deviate and said parts of the plant show stress. This test proved that the TR-value for a healthy plant should be within the range of approximately 10-100 ms.

### Example 5

In this example the effect is described of cutting off a leaf from a black nightshade plant (Solanum nigrum) as a result of which the leaf dehydrates. This example shows that dehydration of a leaf can be seen sooner in the TR-image and not in the QEP-image. The fluorescence images were measured with the above-mentioned preferred device according to FIG. 1, yet now with a pulse duration of 15 ms and a time interval between the pulses of 14 ms and in the light at an intensity of 90 μmol/m².second. The measurements were carried out first on a plant that is healthy and intact. The QEP-image of the photosynthetic activity was calculated using a computer for each pixel of the image according to formula 1 from the thirty recorded fluorescence images. This resulted in image 1A of FIG. 6. Subsequently the TR-image of the response of the photosynthetic activity was calculated using a computer for each pixel of the image according to formula 2 from the thirty recorded fluorescence images. This resulted in the image 1B of FIG. 6. After about 1 minute the left leaf was cut off from the main stem. After 15, 30 and 60 minutes the measurements and calculations were repeated. For QEP of the photosynthesis this resulted in the images 2A, 3A and 4A, respectively, and for TR of the time response of the photosynthesis it resulted in the images 2B, 3B and 4B, respectively. It cannot be derived from the QEP-images which leaf was cut off. The pixels of the grey areas have a value of QEP that is approximately between 0.3-0.4. The TR-images show very clearly that the left leaf obviously differs from the other leaves. The dehydrating leaf shows a higher value for TR. This could already be seen after 15 minutes in the ultimate tip of the leaf. After 30 minutes the areas that are pale grey have a higher value of TR than the middle grey areas. The pixels of the pale grey areas have a value of TR that is approximately between 300-1000 ms. The pixels of the middle grey areas have a value of TR that is approximately between 50-200 ms. This example shows that when the TR-value exceeds 250 ms the leaf is dehydrating in those small areas. This could not be seen in the QEP-image. Advantage of the present invention is that now dehydration of a leaf is measured in a short time of approximately 500 ms. This as opposed to the methods known up until now in which measurements of the wilting of leaves take a few to tens of seconds.

### Example 6

In this example the effect of salt stress on the QEP-image and TR-image of the photosynthetic activity of the potato plant (Solanum tuberosum) is described. The fluorescence images were measured using the above-mentioned preferred device according to FIG. 1 at a continuous exposure of the plants with an intensity of approximately 40 μmol/m².second and a pulse duration of 15 ms and a time interval between the pulses of 14 ms. FIG. 7A shows the QEP-image of the photosynthetic activity that was calculated using a computer for each pixel of the image according to formula 1 from thirty fluorescence images. Subsequently the TR-image of the response of the photosynthetic activity was calculated using a computer for each pixel of the image according to formula 2 from the thirty recorded fluorescence images. This resulted in the image of FIG. 78. The plant on the left in FIGS. 7A and 78 was treated with a water solution containing salt. The plant on the right is a control plant treated with normal water. In the QEP-image of FIG. 7A a small difference was measured between the plant treated with salt solution and the control plant. The plant treated with salt solution shows a few pale grey specks on the even middle grey areas of the leaves. The pixels have a value of QEP that is approximately between 0.30-0.40. The leaves of the control plant show middle grey even areas. The pixels have a value of QEP that is approximately between 0.35-0.45. In the TR-image of FIG. 7B the difference is much clearer. The older leaves of the plant treated with salt solution are pale grey. The pixels have a value of TR that is approximately between 250-400 ms. The young leaves are dark grey. The pixels have a value of TR that is approximately between 100-150 ms. As expected the salt is stored in the older leaves. The young leaves are healthy and therefore may possibly survive. The control plant is dark grey and is healthy. The pixels have a value of TR that is approximately between 50-150 ms. This example shows that when the TR-value is higher than 200 ms the leaf is not salt-resistant, but said small areas are subjected to stress due to the presence of salt. Advantage of the present invention is that now the salt stress of a whole plant is measured in a short time of approximately 500 ms and in light. This as opposed to the methods known up until now in which measurements could only be carried out in the dark and the effect of salt stress could not be measured.

### Example 7

In this example the effect of rot and a spot in the early stages of rot on kiwifruits (Actinidia chinensis) on the QEP- and TR-image of the photosynthetic activity is described. The fluorescence images were measured using the above-mentioned preferred device according to FIG. 1. In FIG. 8 the QEP- and TR-images of the photosynthetic activity can be seen that were calculated using a computer for each pixel of the image according to formula (1) and (2), respectively, from four fluorescence images. In panel 1A of FIG. 8 the QEP-image can be seen with on the left a fruit of good quality without rot and on the right a fruit having a spot affected by rot. Panel 1B shows the related TR-image. Panel 2A and 2B are analogous to panel 1A and 1B but now the fruit on the right has been replaced by a fruit having a spot in the early stages of rot. On the QEP-recordings of the kiwifruits the black areas in the image are hardly photosynthetically active anymore. The pixels have a value of QEP that is approximately between 0 and 0.05. The pale grey areas are starting to rot. The pixels have a value of QEP that is approximately between 0.05 and 0.20. The healthy parts of the fruit do show a normal value of QEP of the photosynthetic activity. The left fruit that is of good quality is middle grey and said pixels have a value that is approximately between 0.20 and 0.35. In the TR-recordings the area that is rot is dark grey. The pixels in this area have a value that is approximately higher than 150 ms. The spots in the early stages of rot are pale grey. The pixels in this area have a value that is approximately between 50 and 150 ms. The left fruit that is of good quality is coloured black and said pixels have a value that is approximately between 2 and 50 ms. The edges of the kiwifruit are pale grey. This is a fringe effect of the measurement caused by the curvature of the fruit. As a result the intensity of the irradiated LED-light is too low to perform a proper measurement and saturate the photosynthesis. From tests it is known at what threshold values for the QEP-values of the photosynthetic activity the spots of the kiwifruit are in the early stages of rot. Above a certain threshold value of the QEP-value of the photosynthetic activity the kiwifruit is still of a good quality without spots in the early stages of rot. Below a certain threshold value the spots on the kiwifruit are rotting or are in the early stages of rot and the kiwifruit can no longer be sold. This test showed that the threshold value was approximately 0.15. From the same tests it is also known at what threshold values for the TR-value of the photosynthetic activity the spots of the kiwifruit are in the early stages of rot. Below a certain threshold value of the TR-value of the photosynthetic activity the kiwifruit is still of good quality without rot or spots in the early stages of rot. Above a certain threshold value the spots'on the kiwifruit are rot or in the early stages of rot and the kiwifruit can no longer be sold. This test showed that the threshold value was approximately 50 ms. Advantage of the present invention is that now kiwifruits are measured in a short time of approximately 120 ms when irradiating with four pulses and therefore a proper opinion can be given about the presence of rot and spots in the early stages of rot on the fruit based on the QEP-value and TR-value of the photosynthetic activity. This as opposed to the methods known up until now in which rot and spots in the early stages of rot are detected on the basis of colour. Often this is done unsuccessfully as kiwifruits have a dark green/brown colour and spots affected by rot almost have the same colour. The methods known up until now in which chlorophyll fluorescence measurements of kiwifruits are made are too slow and cannot be used to sort large quantities of kiwifruits on the presence of rot in an economically sensible way.

### Example 8

In this example the effect of the quality of petunia (Petunia) seedlings on the QEP-image of the photosynthetic activity is described. The fluorescence images were measured using the above-mentioned preferred device according to FIG. 1 of a tray of petunia seedlings in potting soil in a grid of 9 plants horizontally and 7 plants vertically. In FIG. 9 the QEP-image of the photosynthetic activity can be seen, calculated using a computer for each pixel of the image according to formula (1) from twenty fluorescence images. With the QEP-image each seedling can easily be localised, because only material that contains chlorophyll and is photosynthetically active is visible. On three locations in the 9×7 grid no plants are visible on the QEP-image. Said locations are empty because the seeds did not germinate or because the seedling died and is no longer photosynthetically active. Said empty locations can be filled with new seedlings in order to get a full tray. The seedlings having areas of an even middle grey colour are of good quality. Said healthy seedlings show a normal value of QEP of the photosynthetic activity. The pixels have a value that is approximately between 0.75 and 0.85. The seedlings with pale grey areas are of average quality. Said seedlings show a value of QEP of the photosynthetic activity of which the pixels have a value that is approximately between 0.4 and 0.75. The seedlings having pale grey and dark grey areas had leaves that were damaged. The pixels have a value of QEP of that is approximately between 0 and 0.4. Tests showed at what threshold values for the QEP-value of the photosynthetic activity the seedlings lag behind in growth. Above a certain threshold value of the QEP-value of the photosynthetic activity the seedlings are of a good quality. Below a certain threshold value the seedlings lag behind in growth and need to be replaced for a homogeneous growth and quality of the plants of a tray. This test showed that the threshold value was approximately 0.5. Advantage of the present invention is that now a whole tray of seedlings can be measured in one go in a short time of approximately 600 ms when irradiating with twenty pulses and therefore a proper opinion can be given about the quality of each individual seedling based on the QEP-value of the photosynthetic activity. This as opposed to the methods known up until now in which chlorophyll fluorescence measurements of whole trays is not possible, as said methods can only take images of parts of plants or a few small plants and are too slow to measure large numbers of trays in an economically sensible manner and replace seedlings of inferior quality by new healthy seedlings.

### Example 9

In this example the effect of spots in the early stages of rot on green beans (Phaseolus vulgaris) on the QEP- and TR-image of the photosynthetic activity is described. Using the above-mentioned preferred device according to FIG. 1, the fluorescence images of nine green beans were measured. In FIG. 10A the QEP-image and in 10B the TR-image of the photosynthetic activity can be seen that were calculated using a computer for each pixel of the image according to formula (1) and (2), respectively, from ten fluorescence images. On the left in the QEP-image six green beans can be seen that show mainly dark grey and middle grey areas. The pixels have a value of QEP that is approximately between 0 and 0.4. Said green beans show early rot. On the right three green beans can be seen that are mainly an even pale grey. Said green beans are of good quality and show no early rot. Said green beans show a normal value of QEP of the photosynthetic activity. The pixels have a value that is approximately between 0.4 and 0.8. From tests it is known at what threshold values for the QEP-values of the photosynthetic activity the green beans start showing rot after a few days. Above a certain threshold value of the QEP-value of the photosynthetic activity the green beans are of good quality and remain of good quality for several days without developing rot. Below a certain threshold value the green beans develop rot after a few days. This test showed that the threshold value was approximately 0.4. On the left in the TR-image the same six green beans can be seen that are now specked mainly dark and pale grey. The pixels have a value of TR that exceeds approximately 70 ms. These green beans show spots in the early stages of rot. On the right three green beans can be seen that are mainly middle and pale grey. Said green beans are of good quality and show no spots in the early stages of rot. These green beans show a normal value of TR of the photosynthetic activity. The pixels have a value that is approximately between 20 and 70 ms. From tests it is known at what threshold values for the QEP-value of the photosynthetic activity the green beans start showing rot after a few days. Above a certain threshold value of the TR-value of the photosynthetic activity the green beans are of good quality and remain of good quality for several days without developing rot. Below a certain threshold value the green beans show rot after a few days. This test showed that the threshold value is approximately 70 ms. Advantage of the present invention is that now the quality of green beans can be predicted at high speed. A flow of green beans over a conveyor belt can be measured with the present invention in a short time of approximately 300 ms when irradiating with ten pulses. Inferior quality green beans can be removed from the flow. This as opposed to the methods known up until now in which chlorophyll fluorescence measurements in a flow of green beans on a conveyor belt is not possible on the basis of photosynthetic activity, as the method known up until now is too slow to measure large quantities in an economically sensible manner.

### Example 10

In this example the effect of quality in the form of softening of cucumber (Cucumis sativus) on the QEP- and TR-image of the photosynthetic activity is described. The fluorescence images were measured using the above-mentioned preferred device according to FIG. 1. In FIGS. 11A and B the QEP- and TR-images, respectively, of the photosynthetic activity can be seen that were calculated using a computer for each pixel of the image according to formula (1) and (2), respectively, from twenty fluorescence images. In the QEP- and TR-image the top cucumber is of inferior quality. This fruit is soft to the touch. Below a cucumber of good quality. This fruit is firm to the touch. On the QEP-image the cucumber of inferior quality is specked pale and middle grey. The pixels have a value of QEP that is approximately between 0.3 and 0.5. The fruit of good quality is mainly of an even grey colour with fewer pale grey areas than the cucumber of inferior quality and said pixels have a value that is approximately between 0.40 and 0.6. Tests showed at what threshold values for the QEP-value of the photosynthetic activity the spots of the cucumber are soft. Above a certain threshold value of the QEP-value of the photosynthetic activity the cucumber is still of good quality and is firm to the touch. Below a certain threshold value the cucumber is soft to the touch and therefore can no longer be sold. This test showed that the threshold value was approximately 0.4. In the TR-image the area that is soft is specked pale/middle grey. The pixels in this area have a value that is below approximately 60 ms. The bottom cucumber that is of good quality, is of an even middle grey colour and said pixels have a value that is approximately between 70 and 150 ms. From the same tests as for the QEP-image it is also known at what threshold values for the TR-value of the photosynthetic activity the spots of the cucumber are soft. Above a certain threshold value of the TR-value of the photosynthetic activity the cucumber is still of good quality. Below a certain threshold value the cucumber is soft and can no longer be sold. This test showed the threshold value to be approximately 70 ms. Advantage of the present invention is that now cucumbers are measured in a short time of approximately 600 ms when irradiating with twenty pulses and therefore a proper opinion can be given about the firmness of the cucumber based on the QEP- and TR-values of the photosynthetic activity. This as opposed to the methods known up until now in which the firmness is detected on the basis of colour. Often this is not possible as cucumbers that are less firm colour a paler shade of green. Said paler colour may also be caused under different circumstances, such as position at the plant and racial properties. The methods known up until now in which chlorophyll fluorescence measurements of cucumbers are made are too slow and cannot be used to sort large quantities of cucumbers for firmness in an economically sensible manner.

1. A method for determining the quality of plant material by determining chlorophyll fluorescence images of said plant material, the plant material being irradiated with a beam of electromagnetic radiation comprising one or more such wavelengths, that at least a part of the chlorophyll present is excitated by at least a part of the radiation, wherein the beam of electromagnetic radiation irradiates the whole of the plant material, the beam consists of several consecutive light pulses such that at least the last light pulse saturates the photosynthetic system of the plant material, and for each tight pulse the fluorescence radiation originating from the plant material and associated with the chlorophyll transition, is measured with an imaging detector for obtaining the chlorophyll fluorescence images.

2. A method according to claim 1, wherein a characteristic chlorophyll fluorescence image containing information about the quantum efficiency of the photosynthetic activity of the photosynthetic system of the plant material is calculated with the formula:
QEP(i)=(Fsat(i)−Fstart(i))/Fsat(i)
Fsat(i)=the intensity of the fluorescence of pixel i obtained when the photosynthesis is saturated after a series of pulses,
Fstart(i)=the fluorescence of pixel i measured over the first pulse, and wherein the calculation is carried out for each pixel i of the chlorophyll fluorescence images.

3. A method according to claim 1, wherein a characteristic chlorophyll fluorescence image containing information about the time response of the photosynthetic activity of the photosynthetic system of the plant material is calculated with the formula:
F(t,i)=Fstart(i)+(Fsat(i)−Fstart(i))*(1−Exp(−t/TR(i)))
Fsat (i)=the intensity of the fluorescence of pixel i obtained when the photosynthesis is saturated after a series of pulses,
Fstart(i)=the fluorescence of pixel i measured over the first pulse,
F(t,i)=the course of the fluorescence of pixel i in time, and t =time wherein the calculation is carried out for each pixel i of the chlorophyll fluorescence images.

4. A method according to claim 1, the electromagnetic radiation used for irradiating the plant material having a wavelength of between 200 and 750 nm.

5. A method according to claim 1, the electromagnetic radiation used for irradiating the plant material being generated by a lamp, laser of LED-lamp.

6. A method according to claim 1, the electromagnetic radiation used for irradiating the plant material having an intensity, expressed in quantity of photons, of at least 500 μmol/m².second, a pulse duration of approximately 3 milliseconds and an interval between the pulses of approximately 27 milliseconds.

7. A method according to claim 1, the fluorescence radiation originating from the plant material being measured between 600 and 800 nm.

8. A method according to claim 1, the fluorescence radiation originating from the plant material being measured with an electronic camera consisting of a video camera, CCD-camera, line scan camera or a number of photodiodes or photomultipliers.

9. A device for determining the quality of plant material using the method according to claim 1, comprising a light source for irradiating the whole of the plant material with a beam of electromagnetic radiation comprising one or more such wavelengths, that at least a part of the chlorophyll present in the plant material is excitated by at least a part of the radiation, wherein the beam consists of several consecutive pulses, means for measuring the fluorescence radiation originating from the plant material and associated with each pulse for obtaining a series of chlorophyll fluorescence images and means for processing the chlorophyll fluorescence images for obtaining the characteristic chlorophyll fluorescence images of the quantum efficiency and the time response of the photosynthetic activity of the photosynthetic system of the plant material.

10. A device according to claim 9, wherein the light source for irradiating the plant material consists of LEDs, the means for measuring the fluorescence radiation originating from the plant material consists of a camera and the means for processing the fluorescence images consist of a computer provided with a program for processing the chlorophyll fluorescence images originating from the camera and calculating the characteristic chlorophyll fluorescence images of the quantum efficiency and the time response of the photosynthetic activity of the photosynthetic system of the plant material therefrom.

11. A method for separating plant material consisting of individual components into several fractions each having a different quality, wherein a characteristic chlorophyll fluorescence image is determined for each component using the method according to claim 1 and the fractions of components having the QEP-value and/or the TR-value in the same pre-determined range are collected.

12. A method according to claim 11 , the plant material consisting of plants, cut flowers, leaf material, fruits, berries, vegetables, flowers, flower organs, roots, tissue culture, seeds, bulbs, algae, mosses and tubers of plants.

13. A method according to claim 12, each individual component consisting of separate plants, cut flowers, leaf material, fruits, berries, vegetables, flowers, flower organs, roots, tissue culture, seeds, bulbs, algae, mosses and tubers of plants.

14. A device for separating plant material using the method according to claim 11, comprising a supply part for the plant material, a part for the irradiation of the whole of the plant material with a beam of electromagnetic radiation comprising one or more such wavelengths, that at least a part of the chlorophyll present in the plant material is excitated by at least a part of the radiation, wherein the beam consists of several consecutive pulses, a part for the measuring of the fluorescence radiation originating from the plant material associated with each pulse for obtaining a series of chlorophyll fluorescence images, a part for processing the chlorophyll fluorescence images for obtaining the characteristic chlorophyll fluorescence images of the quantum efficiency and/or the time response of the photosynthetic activity of the photosynthetic system of the plant material and a separation part that works on the basis of one or a combination of both characteristic chlorophyll fluorescence images of the quantum efficiency and the time response of the photosynthetic activity.

15. A method for classifying plant material consisting of individual components into several fractions each having a different quality, wherein a characteristic chlorophyll fluorescence is determined for each component using the method according to 1 and the fractions of components having the QEP-value and/or the TR-value in the same pre-determined range are collected.

16. A method according to claim 15, the plant material consisting of plants, cut flowers, leaf material, fruits, berries, vegetables, flowers, flower organs, roots, tissue culture, seeds, bulbs, algae, mosses and tubers of plants.

17. A method according to claim 16, each individual component consisting of individual plants, cut flowers, leaf material, fruits, berries, vegetables, flowers, flower organs, roots, tissue culture, seeds, bulbs, algae, mosses and tubers of plants.

18. A device for classifying plant material using the method according to claim 15, comprising a moving structure for localising the plant material, a part for the irradiation of the whole of the plant material with a beam of electromagnetic radiation comprising one or more such wavelengths, that at least a part of the chlorophyll present in the plant material is excitated by at least a part of the radiation, wherein the beam consists of several consecutive pulses, a part for the measuring of the fluorescence radiation originating from the plant material and associated with each pulse for obtaining a series of chlorophyll fluorescence images, a part for processing the chlorophyll fluorescence images for obtaining the characteristic chlorophyll fluorescence images of the quantum efficiency and/or the time response of the photosynthetic activity of the photosynthetic system of the plant material and a classification part that works on the basis of one or a combination of both characteristic chlorophyll fluorescence images of the quantum efficiency and the time response of the photosynthetic activity.

19. A method for separating plant material consisting of individual components into several fractions each having a different quality, wherein a characteristic chlorophyll fluorescence image is determined for each component using the a device according to claim 9 and the fractions of components having the QEP-value and/or the TR-value in the same pre-determined range are collected.

20. A method for classifying plant material consisting of individual components into several fractions each having a different quality, wherein a characteristic chlorophyll fluorescence is determined for each component using the device according to claim 9 and the fractions of components having the QEP-value and/or the TR-value in the same pre-determined range are collected.
